(19) United States
(12) Patent Application Publication
(10) Pub. No.: US 2009/0190453 A1
(43) Pub. Date: Jul. 30, 2009

(54) SOLID IMMERSION LENS (SIL) NEAR-FIELD SYSTEM AND METHOD OF CONTROLLING TILT

(75) Inventors: Jin-kyung LEE, Suwon-si (KR); An-sik JEONG, Hwaseong-si (KR); Jong-hyun SHIN, Suwon-si (KR); Kyung-geun LEE, Seongnam-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/267,871

(22) Filed: Nov. 10, 2008

(30) Foreign Application Priority Data
Jan. 29, 2008 (KR) 2008-9004

(51) Int. Cl. G11B 20/18

(52) U.S. Cl. 369/53.19; G9B/20.046

(57) ABSTRACT

In a near-field optical recording/reproducing system and a method of controlling a tilt, the near-field optical recording/reproducing system includes: a light source; an objective lens to focus light emitted from the light source to transmit near-field light to an information storage medium; a PD (photodetector) to receive a portion of the light that is transmitted from the objective lens to the information storage medium and is reflected from the information storage medium, to detect a GES (gap error signal) used for controlling an air gap formed between the objective lens and the information storage medium; a signal processor/determiner to obtain an edge voltage using the GES detected by the PD and determine a tilt control point using the edge voltage; and an adjuster to control a relative tilt between the objective lens and the information storage medium in the tilt control position.

### CROSS-REFERENCE TO RELATED APPLICATION

This application claims all benefits accruing under 35 U.S.C. §119 from Korean Patent Application No. 2008-9004, filed on Jan. 29, 2008, in the Korean Intellectual Property Office, the disclosure of which is incorporated herein by reference.

### BACKGROUND OF THE INVENTION

1. Field of the Invention

Example embodiments of the present invention relate to a near-field system having a solid immersion lens (SIL) and a method of controlling a tilt thereof, and more particularly, to an SIL near-field system for securing a sufficient tilt margin to prevent or reduce collision between the SIL and a surface of an information storage medium, and a method of controlling a tilt thereof.

2. Description of the Related Art

The size of an optical spot is the most important factor affecting storage capacity of an information storage medium, e.g., an optical disc. Information corresponding to marks or pits having small sizes may be recorded and/or reproduced with small optical spots. Thus, the storage density of the information storage medium may be increased if the size of the optical spots is small. A wavelength of light may be reduced or a numerical aperture (NA) of an objective lens may be increased in order to reduce the size of the optical spot. Compact discs (CDs), digital versatile discs (DVDs), high definition DVDs (HD DVDs), and blu-ray discs (BDs) have been developed for different wavelengths of light and NAs in order to reduce the size of the optical spot. Typically, recording and/or reproduction for CDs, DVDs, BDs, and HD DVDs are performed using a far-field recording and/or reproduction technique because a distance between an objective lens and an information storage medium is of a millimeter order, which corresponds to a far-field condition having a dimension of the distance being thousands of times greater than a wavelength of light.

In contrast, in a near-field optical recording and/or reproduction technique, a distance between a lens and an information storage medium is of tens of nano-meter order, and thus, the distance is shorter than a wavelength of light. The near-field optical recording and/or reproduction technique may be simply referred to as a near-field technique. In such a near-field optical recording and/or reproduction technique, even if the same wavelength of light as in the case for far-field optical recording and/or reproduction is used, an NA may still be greater than 1. Therefore, the size of an optical spot may be further reduced to further increase data density on the information storage medium.

An NA may be greater than 1 when using the near-field technique. To explain, an NA in far-field recording and/or reproduction is defined as shown in FIG. 1, while an NA in near-field recording and/or reproduction is defined as shown in FIG. 2. FIG. 2 illustrates a surface recording method of the near-field technique where light is focused on a bottom of a lens.

Referring back to FIG. 1, an NA in a far-field is defined as “sin θ” of an incidence angle “θ” of light incident onto a surface of an information storage medium. Thus, “NA=sin θ=n×sin θ′<1.” As a result, the NA is smaller than 1. Here, “θ′” denotes an angle at which light that is incident through the surface of the information storage medium is refracted and then focused on an information storage layer, and “n” denotes a refraction index of a cover layer that is located between the surface of the information storage medium and the information storage layer of the information storage medium.

Referring now to FIG. 2, a focusing angle of light is multiplied by a refraction index of a lens to define an NA in a near-field. Thus, the NA may be greater than 1. In other words, it is possible that “NA=n×sin θ>1.”

In a typical near-field structure, an air gap or a lubricant layer exists between a bottom of a lens having a refraction index “n” and a surface of an information storage medium. In the case of a near-field optical recording and/or reproduction technique using a solid immersion lens (SIL), if a condensing lens converges an incident light to form a spot on a surface of a ball lens that is located within the condensing lens, a considerable portion of the focused incident light is totally reflected from the ball lens. Light that is totally reflected from the ball lens and has a large focusing angle must exist as an evanescent wave in the air gap or the lubricant layer in order to be transmitted to the information storage medium in near-field optical recording and/or reproduction. Accordingly, the air gap must be maintained within a distance range in which the light can exist as the evanescent wave, in order to transmit the light existing as evanescent wave from the ball lens to the information storage medium.

In general, an air gap, in which light exists as an evanescent wave, is maintained within λ/4. For example, if light with a wavelength of 405 nm is used, an air gap must be maintained within about 100 nm.

Accordingly, it is important to control the air gap when using the near-field recording and/or reproduction technique. Thus, the air gap must be maintained, and a collision between a lens and an information storage medium must be prevented or reduced, in order to realize a stable near-field system.

### SUMMARY OF THE INVENTION

Several aspects and example embodiments of the present invention provide a solid immersion lens (SIL) near-field system for controlling a tilt of an SIL lens in order to increase a margin of the tilt by using a gap error signal (GES) detected for controlling an air gap to prevent or reduce a collision between the SIL and a surface of an information storage medium, and a method of controlling the tilt.

Additional aspects and/or advantages of the invention will be set forth in part in the description which follows and, in part, will be obvious from the description, or may be learned by practice of the invention.

According to an aspect of the present invention, a near-field optical recording/reproducing system includes: a light source; an objective lens to focus light emitted from the light source and to transmit near-field light to an information storage medium; a photodetector (PD) to receive a portion of the light that is transmitted from the objective lens to the information storage medium and is reflected from the information storage medium, in order to detect a gap error signal (GES) used for controlling an air gap formed between the objective lens and the information storage medium; a signal processor/determiner to obtain an edge voltage using the GES detected by the PD and determine a tilt control point using the edge voltage; and an adjuster to control a relative tilt between the objective lens and the information storage medium with respect to the tilt control point.

According to an aspect of the present invention, the adjuster may be an actuator that drives the objective lens to control a tilt of the objective lens relative to the information storage medium with respect to the tilt control point.

According to an aspect of the present invention, the objective lens may include an aspherical lens and a ball lens that realizes a high numerical aperture (NA) via a near-field effect.

According to another aspect of the present invention, a method of controlling a tilt of an objective lens relative to an information storage medium in a near-field optical recording/reproducing system includes detecting a GES using light reflected from the information storage medium for use in controlling an air gap formed between the objective lens and the information storage medium, wherein the objective lens transmits near-field light to the information storage medium; obtaining an edge voltage using the GES; determining a tilt control point using the edge voltage; and controlling a relative tilt between the objective lens and the information storage medium with respect to the tilt control point to avoid collision between the objective lens and the information storage medium during near-field optical recording and/or reproduction.

According to an aspect of the present invention, a voltage value obtained at a time point where a slope of a differential signal of the GES varies may be determined as the edge voltage.

According to an aspect of the present invention, the relative tilt between the objective lens and the information storage medium may be adjusted, a range in which the edge voltage is the lowest may be obtained, and a central point of the range may be determined as the tilt control point of the objective lens.

According to an aspect of the present invention, a method of controlling a relative tilt between an SIL (solid immersion lens) and an information storage medium in a near-field optical recording/reproducing system, includes: detecting a GES (gap error signal) from the light from the SIL to control of a gap distance between the SIL and the information storage medium; obtaining at least one edge voltage indicating a tilt of the SIL from the GES; determining a tilt control point that provides a designated tilt margin using the at least one edge voltage; and positioning the SIL on the tilt control point to base control of the relative tilt between the SIL and the information storage medium to avoid collision between the SIL and the information storage medium during near-field optical recording and/or reproduction.

According to an aspect of the present invention, a near-field optical recording/reproducing apparatus for use with an information storage medium, includes a light source to emit light; an SIL (solid immersion lens) to transmit the light to an information storage medium; a PD (photodetector) to detect a GES (gap error signal) from the light from the SIL, which is used in control of a gap distance between the SIL and the information storage medium; a signal processor/determiner to obtain at least one edge voltage indicating a tilt of the SIL from the GES, and to determine a tilt control point that provides a designated tilt margin using the at least one edge voltage; and an adjuster to position the SIL on the tilt control point to base control of the relative tilt between the SIL and the information storage medium to avoid collision between the objective lens and the information storage medium during near-field optical recording and/or reproduction.

In the near-field optical recording/reproducing system and the method according to example embodiment of the present invention, a tilt margin may be sufficiently secured. Therefore, collision between the SIL and the information storage medium may be prevented or reduced, and a near-field optical recording/reproducing system may be stably realized.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 illustrates a numerical aperture (NA) setup in far-field recording and/or reproduction;

FIG. 2 illustrates an NA setup in near-field recording and/or reproduction;

FIG. 3 is an enlarged view illustrating a relative tilt occurring between a tip of a lens and an information storage medium;

FIG. 4 is a graph illustrating a mechanical tilt margin calculated using a tilt margin equation;

FIG. 5 schematically illustrates a solid immersion lens (SIL) near-field optical recording/reproducing system according to an example embodiment of the present invention;

FIG. 6 illustrates an optical path of light focused on a bottom of a second lens of an SIL unit using a surface recording method;

FIG. 7 illustrates an optical path of light focused in a cover layer of an information storage medium through an air gap formed between the bottom of a second lens of an SIL unit and an information storage medium using a cover inside recording method;

FIG. 8A schematically illustrates a GES obtained when a tip of a lens and an information storage medium are arranged so that a tilt thereof is small;

FIG. 8B schematically illustrates a GES obtained when the tip of the lens and the information storage medium are arranged so that a tilt thereof is greater than in FIG. 8A.

FIG. 9 is a graph illustrating variations in an edge voltage of a GES depending on a tilt given between a ball lens and an information storage medium;

FIGS. 10A and 10B schematically illustrate a method of determining an edge voltage from a position in which a slope varies on a slope graph of a differential signal of a GES, according to an example embodiment of the present invention; and

FIG. 11 is a graph illustrating variations in an edge voltage of a GES depending on a tilt given between a ball lens and an information storage medium using a jig.

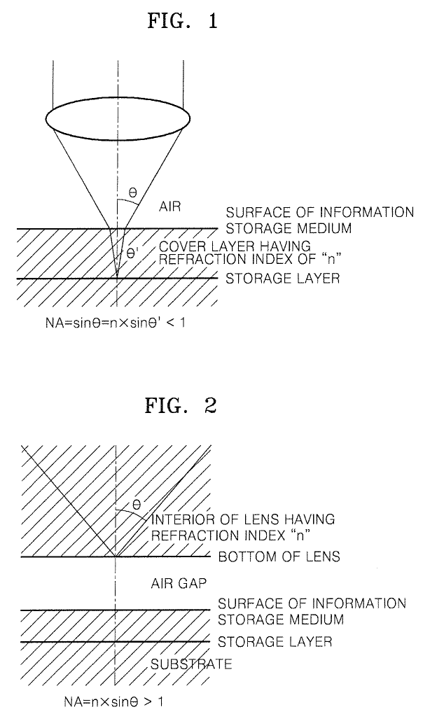

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The example embodiments are described below in order to explain the present invention by referring to the figures.

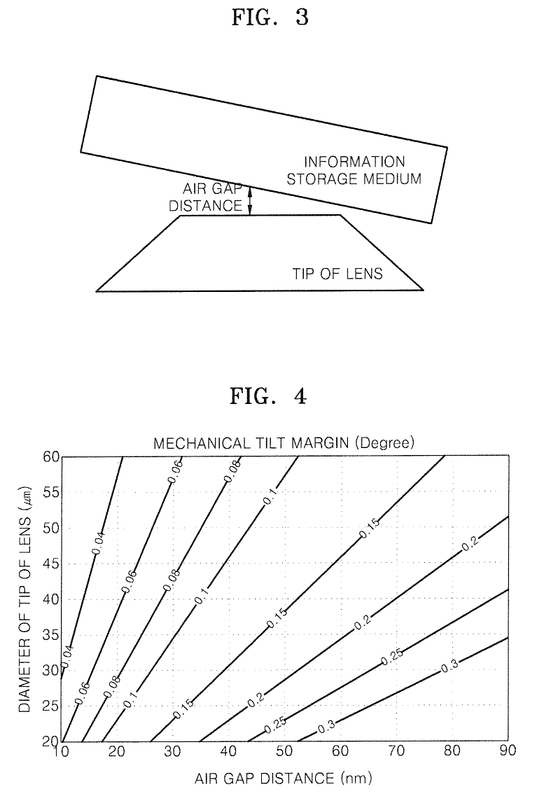

A tilt controlling method of example embodiments of the present invention is performed so that a near-field optical recording/reproducing system secures a maximum tilt margin to prevent or reduce a collision between a solid immersion lens (SIL) and a surface of an information storage medium. FIG. 3 is an enlarged view illustrating a tip of a lens and an information storage medium, i.e., a relative tilt occurring between the lens and the information storage medium. Although an air gap distance between the lens and the information storage medium is kept at a target value, e.g., a value less than or equal to about 100 nm or λ/4, where λ is the wavelength of light used, if the relative tilt occurs between the lens and the information storage medium and the relative tilt is great, collision may occur between the lens and the information storage medium.

A mechanical tilt margin for preventing or reducing such a collision may be determined using two factors, i.e., a radius of the tip of the lens and the air gap distance, as in Equation 1 below:

Mechanical Tilt Margin˜arctan(Air Gap Distance/Radius of the Tip of the Lens). (1)

In a near-field optical recording/reproducing system, a radius of a tip of a lens is generally about tens of micro-meters, and an air gap distance is generally less than or equal to 100 nm.

The mechanical tilt margins based on Equation 1 are illustrated in FIG. 4. Referring to FIG. 4, the horizontal axis denotes the air gap distance in nm, the vertical axis denotes a diameter of the tip of the lens in μm, and the mechanical tilt margin is given in degrees. An air gap distance may be adjusted to be about 30 nm or less, and a size of a tip of a lens is manufactured to be about 50 μm or less. Thus, as shown in FIG. 4, the mechanical tilt margin is considerably small.

Since the mechanical tilt margin for preventing or reducing the collision is 0.1 or less given the above air gap distance and size of a tip of a lens, a signal deterioration problem due to the tilt does not occur within the mechanical tilt margin optically. Thus, the tilt is controlled only to prevent or reduce the collision between the lens and the information storage medium.

Therefore, in a near-field optical recording/reproducing system for performing recording and/or reproduction using a near-field light and having a distance between a lens and a surface of an information storage medium controlled to be less than or equal to a wavelength of light, a relative tilt between the lens and the information storage medium must be controlled to prevent or reduce collision between a tip of the lens and the information storage medium.

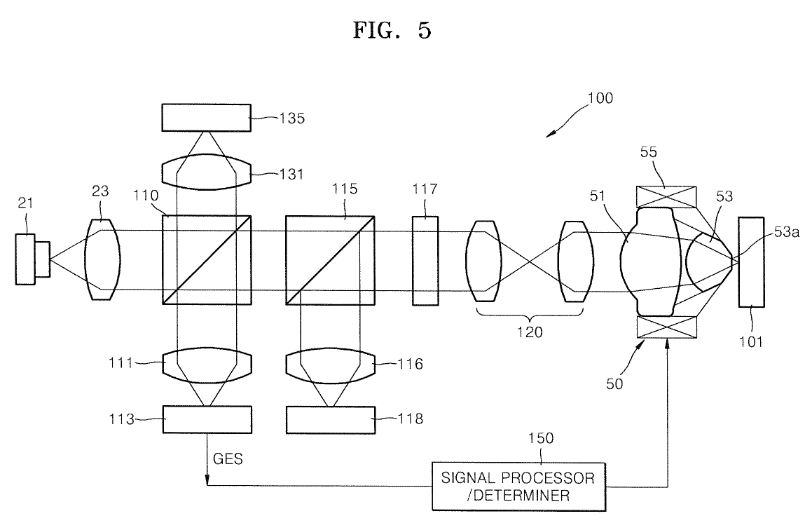

FIG. 5 schematically illustrates a near-field optical recording/reproducing system according to an example embodiment of the present invention. Referring to FIG. 5, a near-field optical recording/reproducing system 100 includes a light source 21, an objective lens, i.e., a solid immersion lens (SIL) unit 50, a first photodetector (PD) 118, first and second optical path changers 115 and 110, a second PD 113, a signal processor/determiner 150, and an adjuster, e.g., an actuator 55. The SIL unit 50 generates near-field light to be used for recording and/or reproducing data to and from an information storage medium 101, and delivers the near-field light to the information storage medium 101.

The first PD 118 receives light reflected from the information storage medium 101 to detect an information signal or an error signal based on the reflected light. The first and second optical path changers 115 and 110 change an advancing path of light that is incident thereon. The second PD 113 detects a gap error signal (GES) for controlling a gap servo. The signal processor/determiner 150 obtains an edge voltage using the GES detected by the second PD 113 and determines a tilt control point for the SIL unit 50 using the edge voltage. The adjuster 55 adjusts a relative tilt between the SIL unit 50 and the information storage medium 101 with respect to the tilt control point determined by the signal processor/determiner 150. The near-field optical recording/reproducing system 100 may further include an optical system 120 that adjusts a focal point and a collimating lens 23 that collimates light emitted from the light source 21 to transform the emitted light into parallel light. In example embodiments of the present invention, the tilt control point refers to a position of the SIL unit 50 that is designated to be a starting position for controlling the tilt of the SIL unit 50. Thus, once the tilt control point is determined based on the edge voltage, the SIL unit 50 is controlled and positioned to the tilt control point.

The light source 21 may include a laser diode that emits linearly polarized light within a predetermined wavelength range. For example, the light source 21 may include a laser diode that emits light in a blue wavelength range, i.e., a wavelength of about 405 nm satisfying the high definition digital versatile disc (HD DVD) and blu-ray disc (BD) standards. Here, the light source 21 may emit light in another wavelength range or band. Power of the light source 21 may be monitored by a monitoring PD 135.

The light emitted from the light source 21 passes through the collimating lens 23. The collimating lens 23 collimates divergent light to be parallel light. The collimated light passes through the second and first optical path changers 110 and 115, and the optical system 120 which adjusts the focal point of the collimated light, and then is incident onto the SIL unit 50.

The first optical path changer 115 changes an advancing path of light that is incident thereon so that light incident from the light source 21 advances toward the SIL unit 50, and light reflected from the information storage medium 101 and having passed through the SIL unit 50 advances toward the first PD 118.

The first optical path changer 115 may be a polarization beam splitter (PBS). In this case, a wave plate, e.g., a quarter wave plate 117, may be further installed in an optical path formed between the first optical path changer 115 and the SIL unit 50. Here, the quarter wave plate 117 changes polarization of light that is incident thereon. Thus, if the first optical path changer 115 is a PBS, and the quarter wave plate 117 is installed as described above, a first linearly polarized light that is emitted from the light source 21, is transmitted through the first optical path changer 115, and is changed into circularly polarized light through the quarter wave plate 117, and is then focused by the SIL unit 50. The circularly polarized light, when reflected from the information storage medium 101, is transformed into another circularly polarized light that is orthogonal thereto. The another circularly polarized light is then changed into another linearly polarized light that is orthogonal thereto through the quarter wave plate 117, and is reflected from the first optical path changer 115 toward the first PD 118.

Here, a portion of light reflected from the information storage medium 101 also may be reflected from the second optical path changer 110, positioned between the light source 21 and the first optical path changer 115, and then detected by the second PD 113 because when an NA is greater than 1, a phase change of P-polarized light is different from a phase change of S-polarized light during total reflection. Thus, a right circularly polarized light that is incident onto the information storage medium 101, when reflected from the information storage medium 101, is changed into left circularly polarized light. Here, the reflected light may partially include the right polarized light in addition to the left circularly polarized light due to a phase change difference. Therefore, a portion of light reflected from the information storage medium 101 is transmitted through the first optical path changer 115, is reflected from the second optical path changer 110, and is then detected by the second PD 113.

The second optical path changer 110 changes an advancing path of light so that light incident from the light source 21 first advances toward the SIL unit 50, and then a portion of light reflected from the information storage medium 101 passes through the SIL unit 50, transmits through the first optical path changer 115, and advances toward the second PD 113 used for the gap servo. The second optical path changer 110 may be a beam splitter that transmits and reflects light that is incident thereon at a predetermined ratio.

Sensor lenses 116 and 111 may be further installed respectively in optical paths formed between the first optical path changer 115 and the first PD 118, and between the second optical path changer 110 and the second PD 113. The monitoring PD 135 may be further installed to detect a portion of light that is incident from the light source 21 and reflected from the second optical path changer 110. The monitoring PD 135 outputs a monitoring signal that is to be used for controlling an amount of light output from the light source 21.

A sensor lens 131 may be further installed in an optical path formed between the monitoring PD 135 and the second optical path changer 110. Light emitted from the light source 21 is mainly linearly polarized light, but may include other linearly polarized components portions that are partially orthogonal thereto. In this case, a portion of light emitted from the light source 21 may be reflected from the first optical path changer 115. Thus, the monitoring PD 135 and the sensor lens 131 may be disposed to detect light that is incident from the light source 21 and partially reflected from the first optical path changer 115, in other example embodiments.

The optical system 120 is used to adjust a focal point of the near-field optical recording/reproducing system 100 used for optical recording and/or reproduction. For example, the optical system 120 may operate to accurately focus the focal point on a bottom 53a of the second lens 53 of the SIL unit 50 facing the information storage medium 101 (i.e., a surface recording method) or inside a cover layer of the information storage medium 101 (i.e., a cover layer inside recording method).

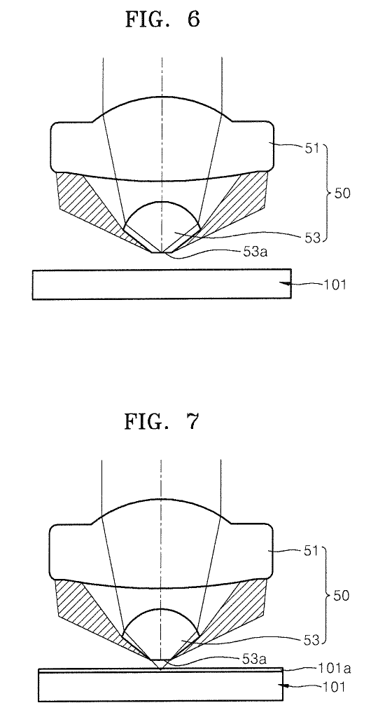

As shown in FIG. 6, for a surface recording method, light is focused on the bottom 53a of the second lens 53 of the SIL unit 50. As shown in FIG. 7, for a cover layer inside recording method, light passes through an air gap formed between the bottom 53a of the second lens 53 of the SIL unit 50 and the information storage medium 101, and then is focused inside a cover layer 101a of the information storage medium 101.

The SIL unit 50 may include first and second lenses 51 and 53 used to record information on an information storage layer of the information storage medium 101, or to reproduce information from the information storage layer, using near-field coupling. The first lens 51 may have a condensing lens structure corresponding to a general objective lens. The first lens 51 may be an aspherical lens. The second lens 53 may be a lens to realize or obtain a high NA using a near-field effect, and may be a ball lens, i.e., a hemispherical lens or a super hemispherical lens. Both sides that angularly face the information storage medium 101 of the second lens 53 may be formed by being cut, for example.

That is, if a diameter of a tip of the second lens 53 is great, the second lens 53 may collide against the information storage medium 101 even at a small tilt angle. Thus, a tilt margin may be reduced. However, if the noted sides of the second lens 53 are formed by being cut at an angle, a tilt margin may be further increased, and pollutants may be easily discharged from the air gap, for example. A metal film (not shown) having a central opening may be coated on the bottom 53a of the second lens 53 in order to inhibit presence of a side lobe in a focus spot intensity profile of light.

When the first lens 51 has a high NA of about 0.77, and the second lens 53 is formed of a material having a refraction index of about 2.38, an effective NA of about 1.84 may be obtained by the SIL unit 50. High recording density may be achieved with the near-field recording using the SIL unit 50 due to a high effective NA. However, the air gap formed between the second lens 53 of the SIL unit 50 and the information storage medium 101 should be maintained within 100 nm or less, though not required, and further preferably, within a range between 20 nm and 30 nm, though not required, due to a rapid increase in a size of a spot and a decay of an evanescent wave. This results in tight gap servo and tilt margin. In other words, a stable gap servo is required in consideration of a small air gap to prevent or reduce a collision between the information storage medium 101 and the second lens 53 of the SIL unit 50 in the near-field optical recording/reproducing system 100. But also, the small air gap causes a very tight tilt margin of the information storage medium 101, which will prevent or reduce collision between the second lens 53 and the information storage medium 101. A tilt control technique according to example embodiments the present invention is directed to increasing a tilt margin as will be described later.

Referring back to FIG. 5, light that is incident onto the information storage medium 101 is reflected from the information storage medium 101, is collected by the SIL unit 50, passes through the optical system 120, and is partially reflected by the first and second optical path changers 115 and 110. Here, the first PD 118 detects an information signal, i.e., a radio frequency (RF) signal, etc., and the second PD 113 detects a gap error signal (GES) that is used as a servo signal for uniformly maintaining the air gap formed between the tip of the second lens 53 of the SIL unit 50 and the information storage medium 101.

A near-field optical recording technique is different from a far-field optical recording technique in that the SIL unit 50 is used. Also, the far-field optical recording technique uses an astigmatic method or spot size detection (SSD) for a focus servo, while the near-field optical recording technique uses the second PD 113 to additionally detect the GES for controlling an air gap or a distance thereof.

In FIG. 5, the near-field optical recording/reproducing system 100 uses a tracking method using one beam to control a tracking servo. Instead of this, in other example embodiments, the near-field optical recording/reproducing system 100 may further include a grating (not shown) that diffracts a beam emitted from the light source 21 into 0^{th}-order and 1^{st}-order beams, in order to use a tracking method using three beams. A tracking signal may be obtained from a signal detected by the first PD 118 in example embodiments of the present invention.

The near-field optical recording/reproducing system 100 according to the example embodiment of the present invention may adjust a relative tilt between the SIL unit 50 and the information storage medium 101 using an actuator 55 that actuates the SIL unit 50. In other words, the adjuster of the near-field optical recording/reproducing system 100 may be the actuator 55. In this case, the SIL unit 50 may be adjusted by way of a tilt to prevent or reduce collision of the SIL unit 50 against the information storage medium 101 by using the actuator 55. The actuator 55 adjusts the relative tilt between the SIL unit 50 and the information storage medium 101 with respect to the tilt control point determined by the signal processor/determiner 150.

The actuator 55 may have a structure identical or similar to a 3-axis or 4-axis driving actuator used in a far-field optical recording and/or reproduction technique, in an example embodiment. Here, 3-axis driving refers to driving in focus, tracking, and radial tilt directions, and 4-axis driving refers to driving in focus, tracking, radial tilt, and tangential tilt directions. The detailed structure of the actuator 55 is well known in the optical recording field, and thus, its illustration will be omitted herein.

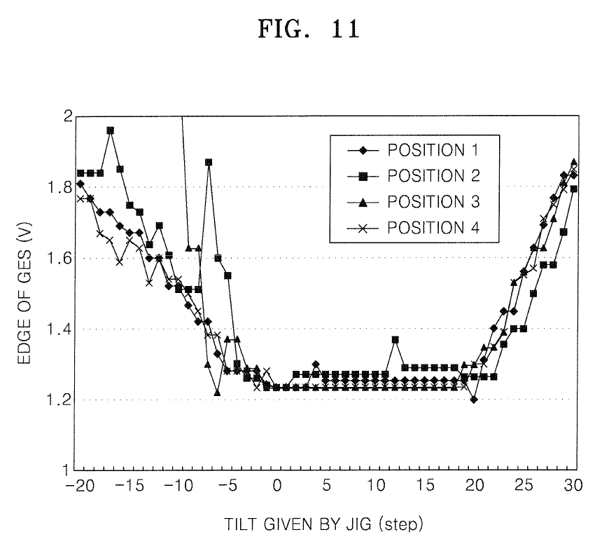

The signal processor/determiner 150 may be constituted to detect an edge voltage using the GES detected by the second PD 113, and to determine the tilt control point using the edge voltage. The signal processor/determiner 150 may also be constituted to generate a tilt control signal to perform a tilt control of the SIL unit 50 relative to the determined tilt control point. When the edge voltage of the GES is detected, the tilt control point is determined using the edge voltage, and the tilt is controlled relative to the tilt control point, a tilt margin of the SIL unit 50 relative to the information storage medium 101 may be increased. The increase in the tilt margin thereof will be described in detail later with respect to FIG. 11.

The signal processor/determiner 150 may generate an air gap control signal from the GES detected by the second PD 113. In this case, the actuator 55 may control the SIL unit 50 according to the air gap control signal, and the tilt control signal, etc. Thus, the air gap formed between the SIL unit 50 and the information storage medium 101 may be controlled to be maintained within a range in which recording and/or reproduction is possible using near-field light.

As previously described, the actuator 55 is used as the adjuster for driving the SIL unit 50 to adjust the tilt of the SIL unit 50 so as to adjust the relative tilt between the SIL unit 50 and the information storage medium 101. However, the present invention is not limited thereto. For example, another type of adjuster may be provided to adjust a tilt of the information storage medium 101. For this, a part of a deck including a spindle motor (not shown) may be tilted, and the adjuster may be constituted using a step motor, or the like, in order to adjust the tilt of the information storage medium 101.

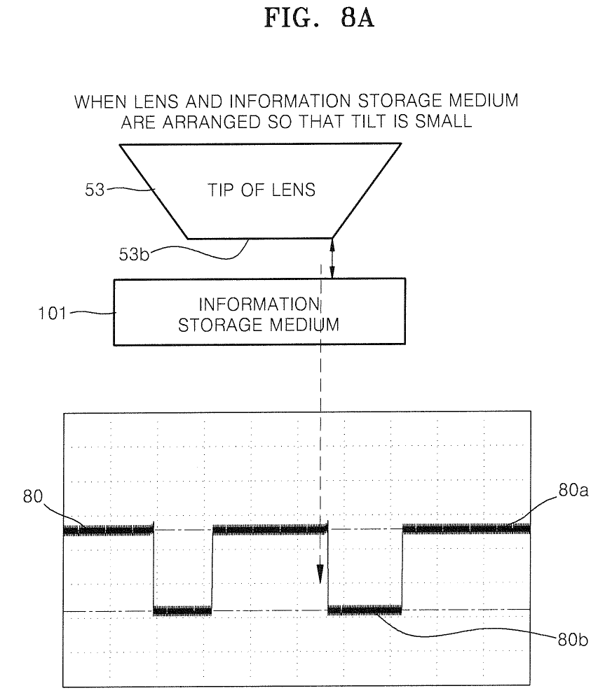

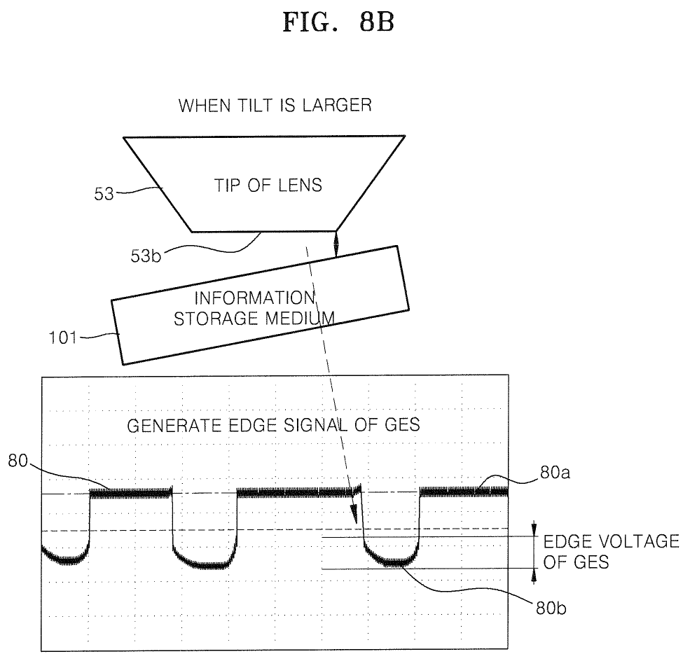

The basis for increasing a tilt margin by detecting an edge voltage of a GES to determine a tilt control point, and by controlling a tilt relative to the tilt control point will now be described in detail. FIG. 8A schematically illustrates a GES generated when a tip 53b of a lens 53 and an information storage medium 101 are arranged so that a tilt is small, and FIG. 8B schematically illustrates a GES generated when the tip 53b of the lens 53 and the information storage medium 101 are arranged so that a tilt is larger, or at least greater than that of FIG. 8A. In example embodiments, a hemispherical or super hemispherical ball lens forming a near-field coupling is arranged based on an optical axis, and then an information storage medium 101 is adjusted with respect to a tip of the ball lens to control the tilt thereof.

As shown in FIG. 8A, if the tip 53b of the lens 53 and the information storage medium 101 are arranged so that a very small tilt occurs, a very clear, rectangular GES 80 is obtained in a contact test. The contact test is an arrangement process of checking a voltage value generated when the tip 53b of the lens 53 repeatedly contacts, and then separates from, the information storage medium to detect reflected light. Here, a high voltage value corresponds to a case where the tip 53b of the lens 53 maintains a distance of several or more wavelengths from the information storage medium 101, and thus, is referred to as a far-field voltage 80a. A low voltage value corresponds to a case where the tip 53b of the lens 53 approximately contacts the information storage medium 101, and thus, is referred to as a contact voltage 80b.

As shown in FIG. 8B, if a tilt is great, the GES 80 is not as clear and an edge of the GES 80 (or the contact voltage 80b) is not rectangular but round. Here, a voltage obtained at an edge portion of the GES is referred to as an edge voltage 80c.

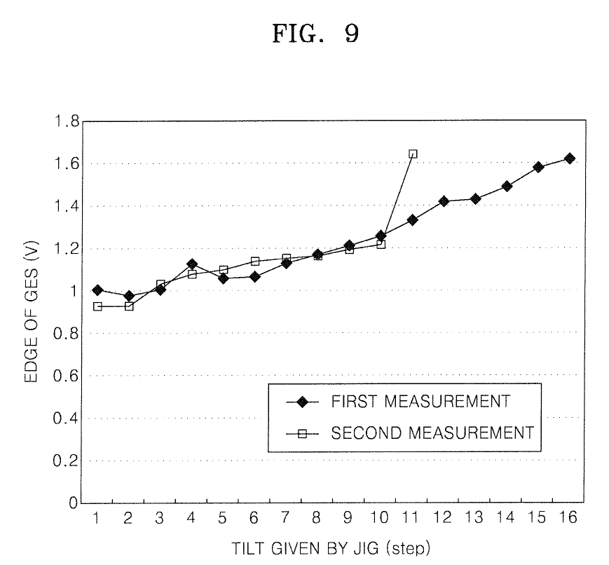

FIG. 9 is a graph illustrating variations in an edge voltage of a GES depending on a tilt given between a tip 53b of the lens 53, such as a ball lens, and an information storage medium 101, where the tilt is obtained by using a jig. The results illustrated in FIG. 9 were obtained using a polycarbonate based information storage medium. Also, the tilt increase was performed in two measurements, i.e., first and second measurements shown, and thus, tendency of the edge voltage of the GES to linearly increase with increased tilt is confirmed. In the example embodiment shown, the increase in the tilt is represented by the increase in steps of the jig. As shown in FIG. 9, the edge voltage linearly increases with the increase in the tilt that corresponds to the increase in the steps of the jig. Therefore, the edge voltage of the GES may be used as a tilt detection signal since detection of the edge voltage would indicate presence of the tilt.

When the tip of the lens and the information storage medium are arranged so that a very small tilt exists as shown in FIG. 8A, the edge of the GES is equal to the lowest voltage of the GES or is not generated. On the other hand, when the tilt is larger as shown in FIG. 8B, the edge of the GES 80 is higher than the lowest voltage (the contact voltage 80b) of the GES 80.

Accordingly, if an edge voltage 80c of a GES 80 is detected and the tip 53b of the lens 53 is adjusted so that the edge voltage 80c is adjusted to be equal to the lowest voltage 80b of the GES 80 or is not generated, a tilt may not occur or the tilt may be controlled to be very small. If the tilt does not occur or a very small tilt occurs, collision between a ball lens and information storage medium 101 may be prevented or reduced.

In example embodiments of the present invention, an edge voltage may be determined to be a point determined by differentiating (or taking a derivative of) the GES to obtain a differential signal of the GES, and selecting a position thereof where a slope of the differential signal of the GES suddenly varies. In example embodiments of the present invention, a differential signal refers to a signal that is obtained by taking a derivative of the GES.

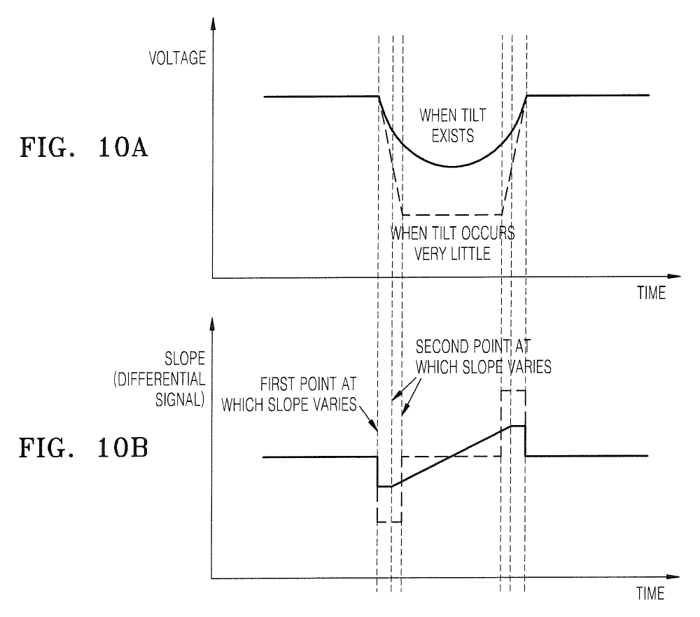

FIGS. 10A and 10B schematically illustrate a method of determining a detection of an edge voltage, i.e., a method of determining (or specifying) the edge voltage as a point in which a slope varies on a slope graph of a differential signal of a GES, according to an example embodiment of the present invention. FIG. 10A shows a graph of the GES relative to time and FIG. 10B shows a slope graph of the differential signal of the GES corresponding to the graph of FIG. 10A. In FIGS. 10A and 10B, a solid line corresponds to a relatively large tilt, while a dashed line corresponds to a very small or no tilt. As shown on the slope graph of the differential signal of the GES of FIG. 10B, the slope of the differential signal of the GES suddenly varies at those points of time that corresponds to when there is a change in the slope of the graph of the GES of FIG. 10A, both when a tilt is small (dashed line) and is considerably great (solid line). Therefore, a voltage value of the GES obtained at a point of time of the GES (shown in FIG. 10A) that corresponds to where the slope of the differential signal of the GES varies, i.e., a second slope variation time point (shown in FIG. 10B), may be determined (or specified) as an edge voltage.

FIG. 10A shows a graph of the GES relative to time. That is, it shows a rate of change of the GES. As the GES is in terms of voltage, and the change in the voltage is over time, the unit for FIG. 10A may be volts per second (v/s), or other units of the change of the voltage over time. Also, FIG. 10B shows a graph of the change in rate of the rate change of GES. That is, FIG. 10B shows how the rate of change of the GES is itself changing over time. Further, as shown in FIG. 10B, the edges in the graph occur where there are changes in the rate of change of the GES, as noted by the arrows pointing to the first and second points at which the slope abruptly changes. In example embodiments, a voltage of the GES (as shown in FIG. 10A) corresponding to one of the edges (as shown in FIG. 10B), where there are changes in the rate of change of the GES, can be specified as an edge voltage. In other example embodiments, the edge voltage may be designated as a voltage of the GES that is lower than the far-field voltage but higher than the contact voltage, or simply as a voltage between the far-field voltage and the contact voltage. FIG. 11 is a graph illustrating variations in an edge voltage of a GES depending on a tilt given between a tip of a lens (e.g., a ball lens) and an information storage medium when using a jig, for example, to provide the tilt. In order to detect a tilt control point that increases an available margin of tilt (or tilt margin), a direct current (DC) tilt is controlled in tangential tilt and radial tilt directions, and variations in an edge voltage of a GES are tracked. As shown in FIG. 11, the variations in the edge voltage of the GES depending on a tilt occurring in the tangential tilt direction were tested over four positions on an information storage medium 101. When the DC tilt is automatically or manually given in a tangential direction to track the variations in the edge voltage of the GES, a position in which the lowest edge voltage of the GES is obtained may be detected.

Referring to FIG. 11, in this example embodiment, the lowest edge voltage of the GES is obtained in a range between about 0 step and about 18 steps of the used jig. Thus, if a tilt is controlled in a position to which about 9 steps have been moved in a plus direction of the jig, a tilt margin may be maximized. The range being the lowest edge voltage of the GES corresponds to a state in which an edge of the GES is equal or approximate to the lowest voltage, i.e., a case where a relative tilt between an SIL unit and an information storage medium, is not great, as it is about 18 steps of the jig in the example embodiment of FIG. 11. Thus, if the tilt is controlled based on a center of the range, the tilt margin may be greatly expanded as compared to when the SIL unit is, for example, simply located at step 5 of the jig.

That is, by the above, a better or optimal placement of the SIL unit 50 to take better advantage of the tilt margin is obtained. As a result, a collision between the SIL unit 50 and the information storage medium 101 may be prevented or reduced. In other words, by determining the range of the tilt margin through use of the edge voltages, and then locating the SIL unit 50 at a designated position, which may be on or about the mid-position (or a central point) of the range, clearance for the tilt of the SIL unit 50 is enhanced in one or more directions so that possibility of collision between the SIL unit 50 and the information storage medium is reduced due to the designated placement of the SIL unit 50.

A tilt control in a radial direction may be performed using the same method as the method used for performing the tilt control in the tangential tilt direction.

A near-field optical recording/reproducing system according to an example embodiment of the present invention may be configured to manually or automatically perform a DC tilt control process for seeking a range in which the lowest edge voltage of a GES is obtained. For example, the actuator 55 may be a 3-axis or 4-axis actuator, and the SIL unit 50 may be adjusted using the actuator 55 to adjust a relative tilt between the SIL unit 50 and an information storage medium 101, and seek a range in which the lowest edge voltage of a GES is obtained. Also, a deck may be manually or automatically adjusted to adjust the relative tilt between the SIL unit 50 and the information storage medium 101, and seek the range in which the lowest edge voltage of the GES is obtained.

A tilt due to an axial run-out exists in each position of an information storage medium 101. Thus, an optimal tilt adjusting point may be varied depending on each position of the information storage medium 101. Therefore, an average tilt control point may be sought from several positions of an information storage medium 101, not from just one position, and a tilt may be controlled relative to the determined average tilt control point. From this viewpoint, FIG. 11 illustrates data on an edge of a GES that was measured depending on a tilt in four positions into which an information storage medium 101 is quadrisected, but such is not required, and the number may be other than four.

If a tilt is controlled in an average tilt control point as described above, a tilt margin may greatly expand on the whole surface of an information storage medium 101 on average. Thus, collision between an SIL unit 50 and the information storage medium 101 may be prevented or reduced during recording and/or reproduction with respect to the whole surface of the information storage medium 101.

It has been exemplarily described that a near-field optical recording/reproducing system using a tilt control method of the example embodiments of the present invention uses an SIL unit as an objective lens. However, the example embodiments of the present invention are not limited thereto. The near-field optical recording/reproducing system may use objective lens of various structures that generate near-field light. Also, a whole structure of the near-field optical recording/reproducing system has been described with reference to FIG. 5. However, the near-field optical recording/reproducing system is not limited thereto and thus may be variously changed in form and details.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example the tilt control point refers to a position of the SIL unit 50 that is designated to be a starting position for controlling the tilt of the SIL unit 50. Thus, once the tilt control point is determined based on the edge voltage, the SIL unit 50 is controlled and positioned to the tilt control point. Also, a differential signal refers to a signal that is obtained by taking a derivative of the GES. Additionally, by determining the range of the tilt margin through use of the edge voltages, and then locating the SIL unit at a designated position, which may be on or about the mid-position (or a central point) of the range, clearance for the tilt of the SIL unit is enhanced in one or more directions so that possibility of collision between the SIL unit and the information storage medium is reduced due to the designated placement of the SIL unit. Accordingly, it is intended, therefore, that the present invention not be limited to the various example embodiments disclosed, but that the present invention includes all embodiments falling within the scope of the appended claims.

What is claimed is:

1. A near-field optical recording/reproducing system comprising:
a light source;
an objective lens to focus light emitted from the light source and to transmit near-field light to an information storage medium;
a PD (photodetector) to receive a portion of the light that is transmitted from the objective lens to the information storage medium and is reflected from the information storage medium, to detect a GES (gap error signal) used for controlling an air gap formed between the objective lens and the information storage medium;
a signal processor/determiner to obtain an edge voltage using the GES detected by the PD and determine a tilt control point using the edge voltage; and
an adjuster to control a relative tilt between the objective lens and the information storage medium with respect to the tilt control point.

2. The near-field optical recording/reproducing system of claim 1, wherein a voltage value obtained at a time point where a slope of a differential signal of the GES varies is determined as the edge voltage.

3. The near-field optical recording/reproducing system of claim 2, wherein the relative tilt is adjusted between the objective lens and the information storage medium so as to obtain a range in which the edge voltage is the lowest, and determine a central point of the range as the tilt control point.

4. The near-field optical recording/reproducing system of claim 1, wherein the relative tilt between the objective lens and the information storage medium so as to obtain a range in which the edge voltage is the lowest, and determine a central point of the range as the tilt control point.

5. The near-field optical recording/reproducing system of claim 1, wherein the adjuster is an actuator that drives the objective lens to control a tilt of the objective lens relative to the information storage medium with respect to the tilt control point.

6. The near-field optical recording/reproducing system of claim 5, wherein the objective lens comprises an aspherical lens and a ball lens that obtains a high NA (numerical aperture) via a near-field effect.

7. The near-field optical recording/reproducing system of claim 1, wherein the objective lens comprises an aspherical lens and a ball lens that obtains a high NA via a near-field effect.

8. A method of controlling a tilt of an objective lens relative to an information storage medium in a near-field optical recording/reproducing system, comprising:
detecting a GES (gap error signal) using light reflected from the information storage medium for use in controlling an air gap formed between the objective lens and the information storage medium, wherein the objective lens transmits near-field light to the information storage medium;
obtaining an edge voltage using the GES;
determining a tilt control point using the edge voltage; and
controlling a relative tilt between the objective lens and the information storage medium with respect to the tilt control point to avoid collision between the objective lens and the information storage medium during near-field optical recording and/or reproduction.

9. The method of claim 8, wherein a voltage value obtained at a time point where a slope of a differential signal of the GES varies is determined as the edge voltage.

10. The method of claim 9, wherein the relative tilt between the objective lens and the information storage medium is adjusted, a range in which the edge voltage is the lowest is obtained, and a central point of the range is determined as the tilt control point.

11. The method of claim 8, wherein the relative tilt between the objective lens and the information storage medium is adjusted, a range in which the edge voltage is the lowest is obtained, and a central point of the range is determined as the tilt control point.

12. The method of claim 8, wherein the objective lens is driven to control a tilt of the objective lens relative to the information storage medium with respect to the tilt control point.

13. A method of controlling a relative tilt between an SIL (solid immersion lens) and an information storage medium in a near-field optical recording/reproducing system, comprising:
detecting a GES (gap error signal) from the light from the SIL to control of a gap distance between the SIL and the information storage medium;
obtaining at least one edge voltage indicating a tilt of the SIL from the GES;
determining a tilt control point that provides a designated tilt margin using the at least one edge voltage; and
positioning the SIL on the tilt control point to base control of the relative tilt between the SIL and the information storage medium to avoid collision between the SIL and the information storage medium during near-field optical recording and/or reproduction.

14. The method of claim 13, wherein the obtaining of the at least one edge voltage comprises:
performing a contact test to repeatedly contact, then separate, the SIL and information storage medium while detecting the GES;
detecting a rate of change of the GES occurring during the performing of the contact test;
detecting at least one change in the rate of change of the GES; and
specifying a voltage of the GES that corresponds to where the at least one change in the rate of change of the GES occurs as the at least one edge voltage.

15. The method of claim 13, wherein the determining of the tilt control point using the at least one edge voltage comprises:
tilting the SIL in at least one direction over at least one position on the information storage medium;
detecting a range of the tilt of the SIL having a lowest value of the at least one edge voltage; and
designating a mid-point of the range of the lowest value of the at least one edge voltage as the tilt control point.

16. A near-field optical recording/reproducing apparatus for use with an information storage medium, comprising
a light source to emit light;
an SIL (solid immersion lens) to transmit the light to an information storage medium;
a PD (photodetector) to detect a GES (gap error signal) from the light from the SIL, which is used in control of a gap distance between the SIL and the information storage medium;
a signal processor/determiner to obtain at least one edge voltage indicating a tilt of the SIL from the GES, and to determine a tilt control point that provides a designated tilt margin using the at least one edge voltage; and
an adjuster to position the SIL on the tilt control point to base control of the relative tilt between the SIL and the information storage medium to avoid collision between the objective lens and the information storage medium during near-field optical recording and/or reproduction.

17. The apparatus of claim 16, wherein the signal processor/determiner obtains the at least one edge voltage by:
detecting a rate of change of the GES occurring during performance of a contact test where the SIL and information storage medium are repeatedly contacted, then separated;
detecting at least one change in the rate of change of the GES; and
specifying a voltage of the GES that corresponds to where the at least one change in the rate of change of the GES occurs as the at least one edge voltage.

18. The apparatus of claim 16, wherein the signal processor/determiner determines the tilt control point by:
detecting a range of the tilt of the SIL having a lowest value of the at least one edge voltage while the SIL is tilted in at least one direction over at least one position on the information storage medium; and
designating a mid-point of the range of the lowest value of the at least one edge voltage as the tilt control point.
